(19) United States
(12) Patent Application Publication
(10) Pub. No.: US 2025/0187120 A1
(43) Pub. Date: Jun. 12, 2025

(54) METHOD AND APPARATUS FOR INSPECTING QUALITY OF WELDING USING SENSORS AND IMAGES

(71) Applicant: PUKYONG NATIONAL UNIVERSITY INDUSTRY-UNIVERSITY COOPERATION FOUNDATION, Busan (KR)

(72) Inventors: Jong Nam KIM, Busan (KR); Jae Eun LEE, Busan (KR)

(73) Assignee: PUKYONG NATIONAL UNIVERSITY INDUSTRY-UNIVERSITY COOPERATION FOUNDATION, Busan (KR)

(21) Appl. No.: 18/896,126

(22) Filed: Sep. 25, 2024

(30) Foreign Application Priority Data
Dec. 12, 2023 (KR) 10-2023-0179565

(51) Int. Cl. B23K 31/12

(52) U.S. Cl. CPC B23K 31/125

(57) ABSTRACT

Proposed are a method and an apparatus for inspecting weld quality using sensors and images. The method includes receiving a dataset consisting of sensor values from a sensor module that is installed in a welding device and measures at least one of voltage, current, and gas flow rate, determining defectiveness according to a number of sensor values smaller than a lower limit value based on the lower limit value calculated from an average of the sensor values included in the dataset, receiving, when the defectiveness is determined, an image of a weld bead corresponding to the dataset, detecting a region of interest corresponding to a weld bead in the image, calculating dimensions of horizontal and vertical lengths of the region of interest, and determining defectiveness depending on whether the dimensions of horizontal and vertical lengths of the region of interest exceed preset thresholds for the horizontal and vertical lengths.

### CROSS REFERENCE TO RELATED APPLICATION

The present application claims priority to Korean Patent Application No. 10-2023-0179565, filed Dec. 12, 2023, the entire contents of which is incorporated herein for all purposes by this reference.

### BACKGROUND

### Technical Field

The present disclosure relates to technology for inspecting the quality of welds.

### Description of the Related Art

Welding is a process used in a diverse range of industries such as automobiles, ships, and construction. Since weld quality is related to safety in each industrial field, it is necessary to produce high-quality weld products. Particularly, in the case of a shear reinforcement of dual anchorage (SDR) used to improve the strength and safety of structures at construction sites, product quality inspection is essential because the welding quality of the product is directly related to safety.

Most small and medium-sized companies perform weld quality inspection relying on the worker's visual inspection. The quality inspection method using the naked eye has the disadvantage of lowering reliability and taking a long time as inspection results may vary depending on the condition and expertise of an operator.

Accordingly, technologies that automatically inspect weld quality using sensors or images are being disclosed. Weld quality inspection technology using sensors has the advantage of being able to inspect quickly with high accuracy, but has the limitation of not knowing the location of a welded area.

Weld quality inspection technology using images of weld beads makes it possible to identify the location of a welded area, but accuracy may be reduced due to noise, and data processing requires a lot of time and money.

### DOCUMENT OF RELATED ART

(Patent Document 1) Korean Patent Application No. 10-2022-0014802
(Patent Document 2) Korean Patent Application No. 10-2021-0161210

### SUMMARY

Accordingly, the present disclosure has been made keeping in mind the above problems occurring in the related art, and the present disclosure is intended to provide a method and an apparatus for inspecting weld quality using sensors and images, seeking to inspect the quality of weld beads by comprehensively using sensor values measured from a sensor and images taken of a weld bead.

Objectives of the present disclosure are not limited to the objective mentioned above, and other objectives not mentioned can be clearly understood from the description below.

In order to achieve the above objective, according to an aspect of the present disclosure, there is provided a method for inspecting weld quality using sensors and images, which is being performed by an electronic device, the method including: receiving a dataset consisting of sensor values measured over time from a sensor module that is installed in a device where welding is performed and measures at least one of voltage, current, and gas flow rate; determining defectiveness according to a number of sensor values smaller than a lower limit value based on the lower limit value calculated from an average of the sensor values included in the dataset; receiving, when the defectiveness is determined as a result of the determining of defectiveness according to the number of sensor values, an image in which a weld bead is captured corresponding to the dataset; detecting a region of interest corresponding to a weld bead in the image; calculating dimensions of horizontal and vertical lengths of the region of interest; and determining defectiveness depending on whether the dimensions of horizontal and vertical lengths of the region of interest exceed respective preset thresholds for the horizontal and vertical lengths.

According to another aspect of the present disclosure, there is provided an apparatus for inspecting weld quality using sensors and images, the apparatus including: a memory configured to store instructions; and a processor, as the processor executes the instructions stored in the memory, configured to: receive a dataset consisting of sensor values measured over time from a sensor module that is installed in a device where welding is performed and measures at least one of voltage, current, and gas flow rate; determine defectiveness according to a number of sensor values smaller than a lower limit value based on the lower limit value calculated from an average of the sensor values included in the dataset; receive, when the defectiveness is determined as a result of the determining of defectiveness according to the number of sensor values, an image in which a weld bead is captured corresponding to the dataset; detect a region of interest corresponding to a weld bead in the image; calculate dimensions of horizontal and vertical lengths of the region of interest; and determine defectiveness depending on whether the dimensions of horizontal and vertical lengths of the region of interest exceed respective preset thresholds for the horizontal and vertical lengths.

According to the present disclosure, the speed and accuracy of weld quality inspection can be improved by comprehensively analyzing sensor values measured by a sensor and the images taken of a weld bead.

The effects of the present disclosure are not limited to those mentioned above, and other effects not mentioned will be clearly understood by those skilled in the art from the description of the claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart of a method for inspecting weld quality using sensors and images according to an embodiment of the present disclosure;

FIG. 2 is a flowchart detailing the steps for detecting a region of interest in a method for inspecting weld quality using sensors and images according to an embodiment of the present disclosure; and

FIG. 3 is a block view of an apparatus for inspecting weld quality using sensors and images according to an embodiment of the present disclosure.

### DETAILED DESCRIPTION

The advantages and features of the present disclosure and methods for achieving them will become clear by referring to the embodiments described in detail below in conjunction with the accompanying drawings. However, the present disclosure is not limited to the embodiments disclosed below and will be implemented in various different forms. The embodiments are provided solely to ensure that the disclosure of the present disclosure is complete and to fully inform those skilled in the art to which the present disclosure pertains of the scope of the present disclosure, and the present disclosure is defined only by the claims. Meanwhile, the terminology used herein is for describing the embodiments and is not intended to limit the present disclosure. As used herein, singular forms include plural forms unless the context specifically dictates otherwise.

The present disclosure relates to a technology t for inspecting the quality of products with weld beads created due to a welding operation as bad or good.

More particularly, the present disclosure is characterized by improving the speed and accuracy of quality inspection by comprehensively using sensor values measured from a device where welding work is performed and images taken of a welded product.

A method for inspecting weld quality using sensors and images according to an embodiment of the present disclosure may be implemented as computer instructions that are stored in a processor or memory of an electronic device capable of data processing (e.g., a general-purpose computer, a special-purpose computer, a portable laptop computer, or a network computer) and perform designated functions.

A method for inspecting weld quality using sensors and images according to an embodiment of the present disclosure may be performed by an apparatus for inspecting weld quality using sensors and images according to another embodiment of the present disclosure.

For the convenience of explanation below, the reference numerals will match for functionally identical contents and repeated descriptions thereof are avoided.

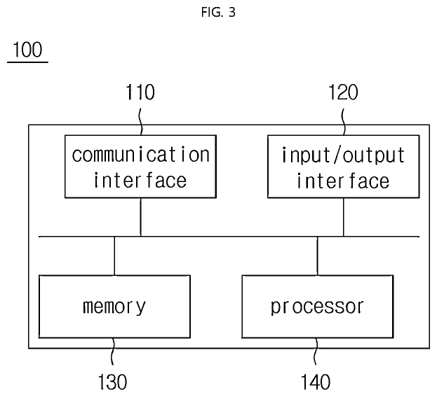

Referring to FIG. 3, an apparatus 100 for inspecting weld quality using sensors and images according to another embodiment of the present disclosure may include a communication interface 110, an input/output interface 120, a memory 130, and a processor 140.

The communication interface 110 is connected to an external user terminal through a network and may receive input according to the user's input and output data processing results to the user terminal.

In this case, the user terminal may be a desktop, a laptop, a tablet, a smartphone, etc.

The input/output interface 120 is connected to an input or output device and may receive user input through an input device or output data processing results through an output device.

In this case, the input device may be a mouse, a keyboard, etc., and the output device may be a display, etc.

Depending on the embodiment, an input/output device capable of both input and output, such as a touch display, may be connected to the input/output interface 120.

The memory 130 may store preset commands to perform the method for inspecting weld quality using sensors and images according to an embodiment of the present disclosure.

The processor 140 may perform the method for inspecting weld quality using sensors and images according to an embodiment of the present disclosure by executing instructions stored in the memory 130.

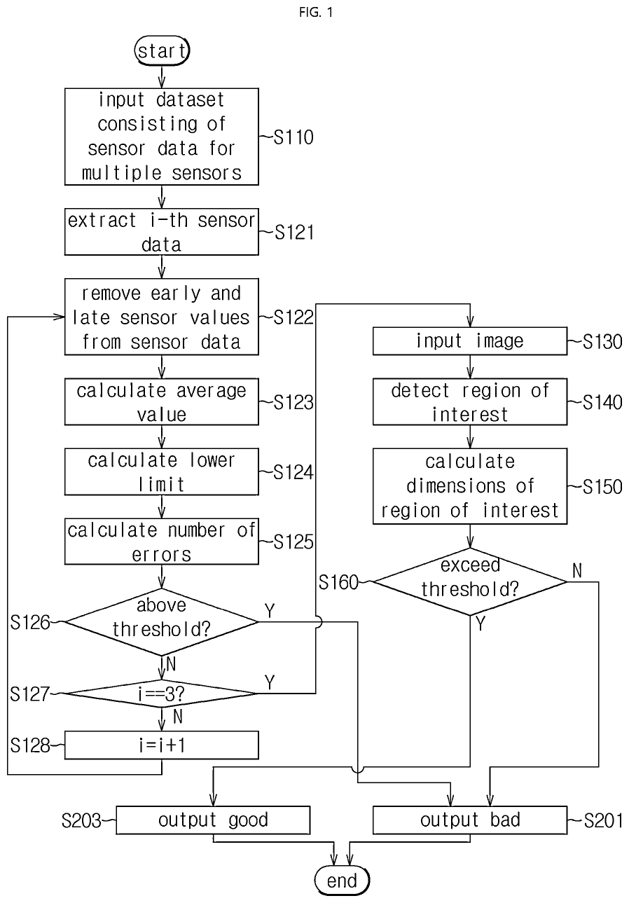

Referring to FIG. 1, the processor 140 is installed in a device where welding is carried out by a user through the communication interface 110 or the input/output interface 120, and may receive a dataset consisting of sensor values measured over time from a sensor module that measures at least one of voltage, current, and gas flow rate (S110).

In this case, the dataset may be created from sensor values for voltage, sensor values for current, and sensor values for gas flow rate measured at multiple time points by a sensor module that is installed in the device where welding is carried out and that measures sensor values for voltage, sensor values for current, and sensor values for gas flow rate at each point in time while the welding device performs welding work on each product.

The sensor module may include a voltage sensor to measure voltage, a current sensor to measure current, and a gas flow rate sensor to measure gas flow rate, to measure sensor values for voltage, sensor values for current, and sensor values for gas flow rate at each point in time for each product on which welding work is performed in the device where the welding work carried out and transmit the measured sensor values to an external device.

The dataset may be created by recording sensor values transmitted from the sensor module during the time welding work is performed for each product and may be input from the user through the communication interface 110 or the input/output interface 120.

The dataset may include: first sensor data consisting of voltage sensor values corresponding to multiple time points for each product; second sensor data consisting of current sensor values corresponding to multiple time points for each product; and third sensor data consisting of gas flow sensor values corresponding to multiple time points for each product.

The processor 140 may determine defectiveness on the basis of the number of sensor values that are smaller than the lower limit based on the lower limit calculated from the average of the sensor values included in the dataset.

The processor 140 may sequentially extract the first sensor data, the second sensor data, and the third sensor data, and determine defectiveness on the basis of the number of sensor values that are smaller than the lower limit based on the lower limit for each sensor data calculated from the average of the sensor values included in each extracted sensor data.

To be specific, the processor 140 may extract any one of the first sensor data, second sensor data, and third sensor data included in the dataset on the basis of a repetition index i having an initial value (e.g., 1) preset to correspond to the order of sensor data for voltage (S121).

The processor 140 may remove sensor values corresponding to the early and late stages among the sensor values for the multiple time points included in the extracted sensor data (S122).

The processor 140 may remove sensor values up to a preset order from the front and sensor values up to a preset order from the back among the sensor values for the multiple time points included in the extracted sensor data (S122).

For example, the processor 140 may remove sensor values up to the third time point from the front and sensor values up to the third point from the back among the sensor values for the multiple time points included in the extracted sensor data.

Sensor values measured while the welding device performs welding work on each product tend to be unstable at the beginning and end regardless of weld quality. In the present disclosure, the accuracy of quality judgment using sensor values is improved by excluding unstable early and late sensor values.

The processor 140 may calculate (S123) the average of the sensor values included in the sensor data from which the sensor values corresponding to the early and late stages are removed, the lower limit for each sensor data by calculate (S124) multiplying the calculated average by a preset ratio, and calculate (S125) the number of errors by counting sensor values that are smaller than the calculated lower limit among the sensor values included in the sensor data from which the sensor values corresponding to the early and late stages have been removed.

At this time, the ratio for calculating the lower limit may be empirically derived through experiment and set in advance. For example, the ratio for calculating the lower limit may be preset to 0.5 according to user input.

An addition, the processor 140 may determine (S126) a weld defect based on a sensor depending on whether the calculated number of errors is greater than or equal to a preset threshold.

At this time, the threshold determining defects based on a sensor may be empirically derived through experiment and set in advance.

For example, assuming that the accuracy was highest at 98% when the threshold was set to 5 as a result of experimenting with changing the threshold for determining defects, the threshold for determining defects based on a sensor may be set to 5 by the user, but is not limited thereto.

The processor 140 may determine a defect when the calculated number of errors is more than a preset threshold, and output a preset first judgment value for defects (S201).

When the calculated number of errors is not more than the preset threshold, the processor 140 may determine (S127) whether the repetition index i corresponds to a preset reference value (e.g., 3) to correspond to the order of sensor data for gas flow rate. When the repetition index i does not correspond to the preset reference value (e.g., 3), the processor 140 may increase (S128) the repetition index i by one, and return to step S121 to extract sensor data for the repetition index.

According to the above configuration, sensor data for voltage, sensor data for current, and sensor data for gas flow rate may be sequentially extracted from the dataset to determine defectiveness on the basis of the sensor values included in the sensor data.

Thus, when the values measured during welding are not uniform, sensor data may be analyzed in the order of voltage, current, and gas flow rate, which are the order in which defects frequently occur.

That is, when analyzing sensor data related to voltage, current, and gas flow rate, sensor data may be analyzed in the order of frequent occurrence as a cause of defects.

Accordingly, the safety of quality inspection may be improved and the inspection time may be shortened by using sensor values from multiple sensors.

When it is determined that the repetition index i corresponds to the preset reference value in step S127, which determines whether the repetition index i corresponds to the preset reference value, in other words, when no defects are determined as a result of sequentially extracting the sensor data for voltage, sensor data for current, and sensor data for gas flow rate from the dataset and judging defectiveness on the basis of the sensor values included in the sensor data, the processor 140 may receive (S130) an image of a weld bead captured corresponding to the dataset from the user.

In this case, the image of the weld bead is created by capturing a welded product including the weld bead, and may be matched in advance with a dataset consisting of sensor values measured during the time a welding operation is performed for each welded product.

The processor 140 may detect (S140) a region of interest corresponding to the weld bead in the input image.

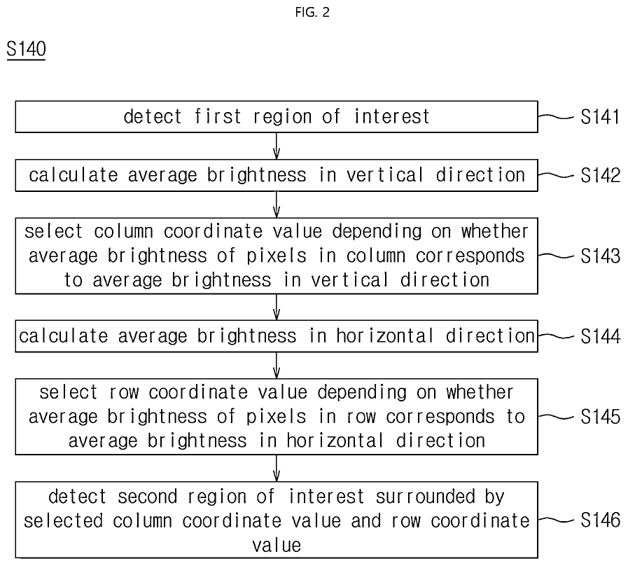

Referring to FIG. 2, the processor 140 may detect (S140) a first region of interest including the weld bead in the image.

In this case, detection of the first region of interest may be achieved according to the user's input to label the area containing the weld bead in the image as a box area.

The processor 140 may detect (S141) the first region of interest including the weld bead by receiving the labeled image in which the area containing the weld bead is labeled in the image taken of the weld bead according to the user's input, and by inputting the image input in step S130 into a learning model that has been trained in advance to detect the area corresponding to the weld bead in the image.

The labeling by the user is usually done in the form of a box, and the box has a larger area with a predetermined amount of spacing than the area corresponding to the actual weld bead to include the weld bead.

As a result, if the first region of interest is used as is, pixels that do not correspond to the weld bead may be included, unnecessarily increasing the amount of calculation.

To detect a more detailed region of interest corresponding to the weld bead from the first region of interest, the processor 140 may calculate (S142) the average brightness in the vertical direction by averaging the brightness averages for each column calculated by averaging pixel values of the pixels included in the first region of interest for each column, and select (S143) a column coordinate value for a column depending on whether the average brightness of each column corresponds to the average brightness in the vertical direction.

In this case, the column coordinate value for a column is a value obtained by counting the columns of pixels consisting the first region of interest from the leftmost, and columns located more to the right may have larger values.

The processor 140 may select (S143) a first column coordinate value that is the minimum value and a second column coordinate value that is the maximum value among the column coordinate values for the columns in which the average brightness calculated for each column is greater than the average brightness in the vertical direction in the columns consisting the first region of interest.

The processor 140 may calculate (S144) the average brightness in the horizontal direction by averaging the brightness averages for each row calculated by averaging the pixel values of the pixels included in the first region of interest for each row, and select (S145) a row coordinate value for a row depending whether the average brightness of each row corresponds to the average brightness in the horizontal direction.

At this time, the row coordinate value for a row is a value obtained by counting the rows of pixels consisting the first region of interest from the uppermost, and the lower the row, the larger the value.

The processor 140 may select (S145) a first row coordinate value that is the minimum value and a second row coordinate value that is the maximum value among the row coordinate values for the rows in which the average brightness calculated for each row is greater than the average brightness in the vertical direction in the rows consisting the first region of interest.

The processor 140 may detect (S146) a second region of interest surrounded by a plurality of coordinates according to a combination of the first and second column coordinate values and the first and second row coordinate values selected in the first region of interest.

According to the above configuration, the processor 140 may detect the second region of interest by excluding pixels that do not correspond to the weld bead from the first region of interest detected based on the area labeled by the user.

Thereafter, the processor 140 may calculate (S150) the dimensions for each of the horizontal and vertical lengths of the detected region of interest.

The processor 140 may calculate the dimension for the horizontal length by subtracting the first column coordinate value from the second column coordinate value and calculate the dimension for the vertical length by subtracting the first row coordinate value from the second row coordinate value (S150).

The processor 140 may determine (S160) a defect based on an image, depending on whether the horizontal and vertical dimensions of the region of interest exceed the preset threshold values for horizontal and vertical lengths.

The processor 140 may determine (S160) a defect based on an image, depending on whether the dimension for the horizontal length exceeds a first preset threshold for the horizontal length and whether the dimension for the vertical length exceeds a second preset threshold for the vertical length.

When the dimension for the horizontal length exceeds the first preset threshold for the horizontal length and the dimension for the vertical length exceeds the second preset threshold for the vertical length, the processor 140 may determine a defect and output the preset first judgment value for defects (S201).

On the other hand, when the dimension for the horizontal length doesn't exceed the first preset threshold for the horizontal length and the dimension for the vertical length doesn't exceed the second preset threshold for the vertical length, the processor 140 may determine no defects (good) and output a preset second judgment value for good (S203).

At this time, the first judgment value for defects and the second judgment value for good may be set in advance by the user so as to confirm defects or no defects.

Below, an experiment was conducted to confirm that when weld quality was inspected according to an embodiment of the present disclosure, speed and accuracy were improved compared to existing technology.

As experimental conditions, 400 datasets and images for SRD shear reinforcement with good quality of welding and 12 datasets and images for SRD shear reinforcement with poor quality of welding were used, using a PC with Windows 10 Pro, i9 with NVIDIA Geforce RTX 3080 (NVIDIA, Santa Clara, CA), GDDR6X 10 GB, 3.7 GHz processor, and Python 3.8 specifications, quality inspection performance and time required for quality inspection were measured when only sensors were used, when only images were used, and when the sensors and images were comprehensively used according to the present disclosure.

For quality inspection performance indicators, accuracy, precision, recall, and F1-score were used.

The table below shows the quality inspection performance indicators and time required as a result of the experiment.

TABLE 1

| | Accuracy | Precision | Recall | F1-score | Time (s) |
|---|---|---|---|---|---|
| Sensor | 99.80 | 99.79 | 100 | 99.89 | 1.496 |
| only | | | | | |
| Image only | 99.59 | 99.59 | 100 | 99.79 | 26.495 |
| present | 100 | 100 | 100 | 100 | 25.736 |
| disclosure | | | | | |

Referring to the table above, quality judgment using only one of the sensors and images generally showed high accuracy, but the performance index for accuracy was less than 100 because defective products were incorrectly classified as good. In comparison, in the case of the present disclosure, the performance index for accuracy is 100 for all 412 samples, confirming that the quality is judged more accurately compared to using only either the sensors or the images.

In addition, it can be seen that the time required for inspection is shorter than when using only images.

According to the present disclosure, by comprehensively considering sensors and images to determine weld quality, the limitation of conventional technologies using only sensors, which is the inability to determine the location of a weld bead, may be solved, and the accuracy of quality judgment may be improved while improving the slowdown in speed, which is a problem with conventional technologies using only images.

Meanwhile, since the steps in the attached flowchart may be implemented with computer program instructions, and the computer program instructions may be stored in computer-readable memory, the functions described in the steps of the flowchart may also be produced as articles containing instruction means to perform the functions.

A person skilled in the art to which the present disclosure pertains will understand that the present disclosure may be implemented in other specific forms without changing its technical idea or essential features. Therefore, the embodiments described above should be understood in all respects as illustrative and not restrictive. The scope of the present disclosure is indicated by the scope of the patent claims described later rather than the detailed description above, and all changes or modified forms derived from the scope of the patent claims and their equivalent concepts should be construed as being included in the scope of the present disclosure.

What is claimed is:

1. A method for inspecting weld quality using sensors and images, which is being performed by an electronic device, the method comprising:
receiving a dataset consisting of sensor values measured over time from a sensor module that is installed in a device where welding is performed and measures at least one of voltage, current, and gas flow rate;
determining defectiveness according to a number of sensor values smaller than a lower limit value based on the lower limit value calculated from an average of the sensor values included in the dataset;
receiving, when the defectiveness is determined as a result of the determining of defectiveness according to the number of sensor values, an image in which a weld bead is captured corresponding to the dataset;
detecting a region of interest corresponding to a weld bead in the image;
calculating dimensions of horizontal and vertical lengths of the region of interest; and
determining defectiveness depending on whether the dimensions of horizontal and vertical lengths of the region of interest exceed respective preset thresholds for the horizontal and vertical lengths.

2. The method of claim 1, wherein the receiving of the dataset is to receive the dataset generated from the sensor module that is installed in the device where welding is performed and measures sensor values for voltage, sensor values for current, and sensor values for gas flow rate at each point in time, and configured to include: first sensor data consisting of voltage sensor values corresponding to multiple time points; second sensor data consisting of current sensor values corresponding to multiple time points; and third sensor data consisting of gas flow sensor values corresponding to multiple time points.

3. The method of claim 2, wherein in the determining of defectiveness according to the number of sensor values, the defectiveness is determined according to a number of sensor values smaller than a lower limit value based on the lower limit value for each sensor data calculated from an average of sensor values included in each extracted sensor data after sequentially extracting the first sensor data, the second sensor data, and the third sensor data included in the dataset.

4. The method of claim 3, wherein the determining of defectiveness according to the number of sensor values comprises:
extracting any one of the first sensor data, the second sensor data, and the third sensor data included in the dataset;
calculating an average of sensor values included in the extracted sensor data;
calculating the lower limit value for each sensor data by multiplying the calculated average by a preset ratio;
calculating a number of errors by counting sensor values, which are smaller than the lower limit value calculated for each sensor data, among the sensor values included in each sensor data; and
determining defectiveness depending on whether the calculated number of errors is greater than or equal to a preset threshold.

5. An apparatus for inspecting weld quality using sensors and images, the apparatus comprising:
a memory configured to store instructions; and
a processor, as the processor executes the instructions stored in the memory, configured to: receive a dataset consisting of sensor values measured over time from a sensor module that is installed in a device where welding is performed and measures at least one of voltage, current, and gas flow rate; determine defectiveness according to a number of sensor values smaller than a lower limit value based on the lower limit value calculated from an average of the sensor values included in the dataset; receive, when the defectiveness is determined as a result of the determining of defectiveness according to the number of sensor values, an image in which a weld bead is captured corresponding to the dataset; detect a region of interest corresponding to a weld bead in the image; calculate dimensions of horizontal and vertical lengths of the region of interest; and determine defectiveness depending on whether the dimensions of horizontal and vertical lengths of the region of interest exceed respective preset thresholds for the horizontal and vertical lengths.

6. The apparatus of claim 5, wherein the processor receives the dataset generated from the sensor module that is installed in the device where welding is performed and measures sensor values for voltage, sensor values for current, and sensor values for gas flow rate at each point in time, and configured to include: first sensor data consisting of voltage sensor values corresponding to multiple time points; second sensor data consisting of current sensor values corresponding to multiple time points; and third sensor data consisting of gas flow sensor values corresponding to multiple time points.

7. The apparatus of claim 6, wherein the processor determines the defectiveness according to a number of sensor values smaller than a lower limit value based on the lower limit value for each sensor data calculated from an average of sensor values included in each extracted sensor data after sequentially extracting the first sensor data, the second sensor data, and the third sensor data included in the dataset.

8. The apparatus of claim 7, wherein the processor, in determining defectiveness according to the number of sensor values, extracts any one of the first sensor data, the second sensor data, and the third sensor data included in the dataset, calculates an average of sensor values included in the extracted sensor data, calculates the lower limit value for each sensor data by multiplying the calculated average by a preset ratio, calculates a number of errors by counting sensor values, which are smaller than the lower limit value calculated for each sensor data, among the sensor values included in each sensor data, and determines defectiveness depending on whether the calculated number of errors is greater than or equal to a preset threshold.
